(19) United States
(12) Patent Application Publication
(10) Pub. No.: US 2025/0193122 A1
(43) Pub. Date: Jun. 12, 2025

(54) METHOD FOR RETRANSMISSION DETECTION OF DATA PACKET AND DEVICE

(71) Applicant: Beijing Volcano Engine Technology Co., Ltd., Beijing (CN)

(72) Inventor: Sai SU, Beijing (CN)

(21) Appl. No.: 18/906,492

(22) Filed: Oct. 4, 2024

(30) Foreign Application Priority Data
Dec. 12, 2023 (CN) 202311708579.2

(51) Int. Cl. H04L 47/34; H04L 1/18; H04L 43/0811

(52) U.S. Cl. CPC H04L 47/34; H04L 1/18; H04L 43/0811

(57) ABSTRACT

The present disclosure provides a method for retransmission detection of a data packet and a device, the method includes: receiving the data packet, and obtaining a packet type and a packet sequence number of the data packet as a current packet type and a current packet sequence number, respectively; obtaining an expected packet sequence number, where the expected packet sequence number is used to indicate an expected data packet to be received before the data packet arrives; determining, according to the current packet type, a data sending state corresponding to the data packet and determining a retransmission detection algorithm corresponding to the data sending state; and calling the retransmission detection algorithm corresponding to the data sending state, and performing the retransmission detection according to the current packet sequence number and the expected packet sequence number, to determine whether the data packet contains retransmitted data.

### CROSS-REFERENCE TO RELATED APPLICATIONS

This application claims priority to Chinese Patent Application No. 202311708579.2, filed on Dec. 12, 2023 and entitled “METHOD FOR RETRANSMISSION DETECTION OF DATA PACKET AND DEVICE”, which is hereby incorporated by reference in its entirety.

### TECHNICAL FIELD

Embodiments of the present disclosure relate to the field of data transmission technologies, and in particular, to a method for retransmission detection of a data packet and a device.

### BACKGROUND

In some data transmission scenarios, transmission is implemented in a form of data packets, and each data packet is used to transmit partial sub-data obtained by dividing original data. Therefore, the original data may be transmitted by one or more such data packets. When transmission of a data packet fails, the data packet may be retransmitted, which is referred to as retransmission for short.

In the prior art, to evaluate transmission reliability, retransmission detection needs to be performed. Specifically, when each data packet is received, a sequence number of the data packet is recorded, and the sequence number of the data packet is analyzed according to a preset time period, to perform retransmission detection, including but not limited to: determining a number of retransmitted data packets, a retransmission rate, and the like.

However, the foregoing solution has problems of large occupied storage space and a large amount of calculation.

### SUMMARY

Embodiments of the present disclosure provide a method for retransmission detection of a data packet and a device, which can reduce occupied storage space and reduce an amount of calculation.

According to a first aspect, an embodiment of the present disclosure provides a method for retransmission detection of a data packet, the method includes:
receiving the data packet, and obtaining a packet type and a packet sequence number of the data packet as a current packet type and a current packet sequence number, respectively;
obtaining an expected packet sequence number, where the expected packet sequence number is used to indicate an expected data packet to be received before the data packet arrives;
determining, according to the current packet type, a data sending state corresponding to the data packet and determining a retransmission detection algorithm corresponding to the data sending state, where the data sending state is used to indicate a corresponding connection state when the data packet is sent; and
calling the retransmission detection algorithm corresponding to the data sending state, and performing the retransmission detection according to the current packet sequence number and the expected packet sequence number, to determine whether the data packet contains retransmitted data.

According to a second aspect, an embodiment of the present disclosure provides an apparatus for retransmission detection of a data packet, the device includes:
a current packet information determining module, configured to receive the data packet, and obtain a packet type and a packet sequence number of the data packet as a current packet type and a current packet sequence number, respectively;
an expected packet sequence number obtaining module, configured to obtain an expected packet sequence number, where the expected packet sequence number is used to indicate an expected data packet to be received before the data packet arrives;
a state determining module, configured to determine, according to the current packet type, a data sending state corresponding to the data packet and determine a retransmission detection algorithm corresponding to the data sending state, where the data sending state is used to indicate a corresponding connection state when the data packet is sent; and
a retransmission detection module, configured to call the retransmission detection algorithm corresponding to the data sending state, and perform the retransmission detection according to the current packet sequence number and the expected packet sequence number, to determine whether the data packet contains retransmitted data.

According to a third aspect, an embodiment of the present disclosure provides an electronic device, including: at least one processor and a memory;
the memory stores a computer-executable instruction; and
the at least one processor executes the computer-executable instruction stored in the memory, so that the electronic device implements the method according to the first aspect.

According to a fourth aspect, an embodiment of the present disclosure provides a computer-readable storage medium, where the computer-readable storage medium stores a computer-executable instruction, and when a processor executes the computer-executable instruction, the computer-executable instruction causes a computing device to implement the method according to the first aspect.

According to a fifth aspect, an embodiment of the present disclosure provides a computer program, where the computer program is used to implement the method according to the first aspect.

Embodiments of the present disclosure provide a method for retransmission detection of a data packet and a device. The method includes: receiving the data packet, and obtaining a packet type and a packet sequence number of the data packet as a current packet type and a current packet sequence number, respectively; obtaining an expected packet sequence number, where the expected packet sequence number is used to indicate an expected data packet to be received before the data packet arrives; determining, according to the current packet type, a data sending state corresponding to the data packet and determining a retransmission detection algorithm corresponding to the data sending state, where the data sending state is used to indicate a corresponding connection state when the data packet is sent; and calling the retransmission detection algorithm corresponding to the data sending state, and performing the retransmission detection according to the current packet sequence number and the expected packet sequence number, to determine whether the data packet contains retransmitted data. Compared with a case of recording identifiers of all data packets, less information is recorded in embodiments of the present disclosure, thereby reducing occupied storage space. In addition, based on less information, an amount of calculation in embodiments of the present disclosure is small. In addition, different retransmission detection algorithms are used for different data sending states in the present disclosure, which helps improve retransmission detection accuracy.

### BRIEF DESCRIPTION OF THE DRAWINGS

In order to more clearly describe the technical solutions in the embodiments of the present disclosure or the prior art, the following briefly describes the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic diagram of a network protocol layer structure of a computer Internet according to an embodiment of the present disclosure.

FIG. 2 is a schematic diagram of a sending process of a TCP (transmission control protocol) data packet according to an embodiment of the present disclosure.

FIG. 3 is a schematic diagram of another sending process of a TCP data packet according to an embodiment of the present disclosure.

FIG. 4 is a schematic diagram of another sending process of a TCP data packet according to an embodiment of the present disclosure.

FIG. 5 is a schematic diagram of another sending process of a TCP data packet according to an embodiment of the present disclosure.

FIG. 6 to FIG. 8 are schematic diagrams of three timeout retransmission processes of a data packet according to embodiments of the present disclosure.

FIG. 9 is a schematic diagram of a data forwarding process based on a cloud network according to an embodiment of the present disclosure.

FIG. 10 is a flowchart of steps of a method for retransmission detection of a data packet according to an embodiment of the present disclosure.

FIG. 11 and FIG. 12 are schematic diagrams of a length of first data in two cases according to an embodiment of the present disclosure.

FIG. 13 to FIG. 15 are schematic diagrams of three sequence number wraparound scenarios according to an embodiment of the present disclosure.

FIG. 16 and FIG. 17 are schematic diagrams of two relationships between a packet sequence number of a probe packet, a hole length, and an expected packet sequence number according to an embodiment of the present disclosure.

FIG. 18 is a schematic diagram of a sequential state according to an embodiment of the present disclosure.

FIG. 19 is a block diagram of a structure of an apparatus for retransmission detection of a data packet according to an embodiment of the present disclosure.

FIG. 20 is a block diagram of a structure of an electronic device according to an embodiment of the present disclosure.

### DESCRIPTION OF EMBODIMENTS

To make the objectives, technical solutions, and advantages of the embodiments of the present disclosure clearer, the technical solutions in the embodiments of the present disclosure will be described clearly and completely with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the protection scope of the present disclosure.

The embodiments of the present disclosure may be applicable to any data packet transmission scenario with a retransmission mechanism. In the data packet transmission scenario, a transmission network may be divided into a plurality of network protocol layers, and some or all of the network protocol layers may have retransmission mechanisms. A typical application scenario of the embodiments of the present disclosure is a transport layer in a computer Internet. The following describes the computer Internet and its network protocol layers in detail.

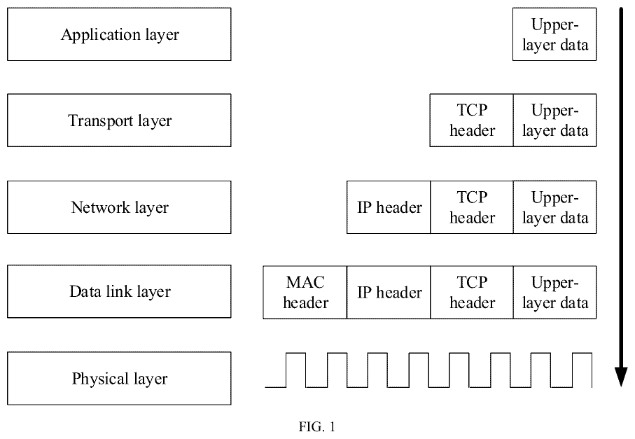

FIG. 1 is a schematic diagram of a network protocol layer structure of a computer Internet according to an embodiment of the present disclosure. As shown in FIG. 1, in the computer Internet, the computer Internet may be divided into five network protocol layers: an application layer, a transport layer, a network layer, a data link layer, and a physical layer. The transport layer has a retransmission mechanism. Therefore, retransmission detection may be performed on the transport layer in the embodiments of the present disclosure. Certainly, an application scenario of the embodiments of the present disclosure is not limited to the transport layer of the computer Internet.

As shown in FIG. 1, the application layer is configured to generate upper-layer data, and may be understood as service data. The application layer is located at the topmost layer.

The transport layer is an important layer in all hierarchical layers, and is the first end-to-end (that is, host-to-host) hierarchical layer. The transport layer is configured to segment the upper-layer data, provide end-to-end reliable or unreliable transmission, and perform error control and flow control. Protocols of the transport layer may include but are not limited to: a TCP (transmission control protocol), a UDP (user datagram protocol), an SPX (sequenced packet exchange) protocol, and the like. The transport layer may add a transport layer header to the upper-layer data according to a used protocol, to obtain transport layer data. As shown in FIG. 1, when the used protocol is TCP, the transport layer header is a TCP header. The transport layer is located at a lower layer of the application layer.

The network layer is configured to add an IP (Internet protocol) header to the transport layer data, to obtain network layer data. The network layer is located at a lower layer of the transport layer.

The data link layer is configured to add a MAC (media accessing control) header to the network layer data, to obtain link layer data. The data link layer is located at a lower layer of the network layer.

The physical layer is configured to convert the link layer data into binary data. The physical layer is located at a lower layer of the data link layer.

When the transport layer uses the TCP protocol, the TCP protocol has a retransmission mechanism. Therefore, the embodiments of the present disclosure may be applied to the transport layer that uses the TCP protocol. The following describes a process of transmitting a data packet by the TCP protocol in detail.

The TCP protocol is a connection-oriented, reliable, and byte-stream-based transport layer protocol. The reliability of the TCP protocol is mainly reflected in connection management, verification, a sequence number mechanism, acknowledgment, timeout retransmission, flow control, and congestion control.

For the TCP protocol, the data packet usually includes a header and a payload. The header may store the following information: information about a sending end, information about a receiving end, a packet sequence number of the data packet, an acknowledgment number, data offset, a reserved bit, a packet type of the data packet, receive window information, an urgent pointer, option information, a checksum, padding information, and the like.

The packet sequence number of the data packet may be represented by 32 bits, and is used to represent an order of each data packet on a TCP connection, so that the sending end sends the data packet according to the sequence number order, and the receiving end assembles and restores data according to the sequence number.

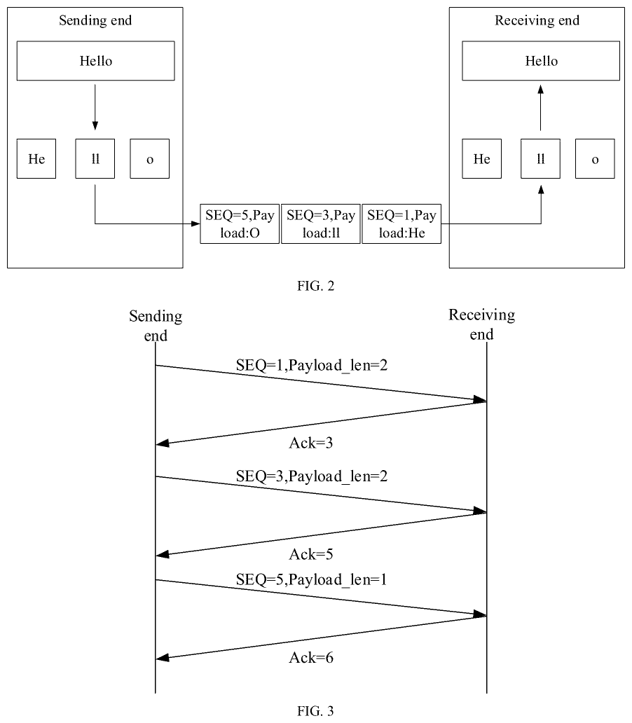

FIG. 2 is a schematic diagram of a sending process of a transmission control protocol (TCP) data packet according to an embodiment of the present disclosure. As shown in FIG. 2, a sending end divides data “Hello” to be sent into three segments: “He”, “11”, and “o”, and forms the following three data packets: a data packet with a packet sequence number SEQ of 1 and a payload Payload of He, a data packet with a packet sequence number SEQ of 3 and a payload Payload of 11, and a data packet with a packet sequence number SEQ of 5 and a payload Payload of o, and sends the three data packets to a receiving end one by one in an ascending order of packet sequence numbers.

When receiving the three data packets, the receiving end assembles the three data packets into received data “Hello” in the ascending order of packet sequence numbers.

After sending the TCP data packets, the receiving end may further send an acknowledgment message to the sending end. FIG. 3 is a schematic diagram of another sending process of a TCP data packet according to an embodiment of the present disclosure. As shown in FIG. 3, the sending end first sends a data packet with a packet sequence number SEQ of 1 and a payload length Payload_len of 2. Correspondingly, after receiving the data packet, the receiving end replies with an acknowledgment message to indicate, by using an Ack, that data before a data sequence number 3 has been received by the sending end. Then, the sending end sends a data packet with a packet sequence number SEQ of 3 and a payload length Payload_len of 2. Correspondingly, after receiving the data packet, the receiving end replies with an acknowledgment message to indicate, by using an Ack, that data before a data sequence number 5 has been received by the sending end. Finally, the sending end sends a data packet with a packet sequence number SEQ of 5 and a payload length Payload_len of 1. Correspondingly, after receiving the data packet, the receiving end replies with an acknowledgment message Ack=6 to indicate, by using an Ack, that data before a data sequence number 6 has been received by the sending end.

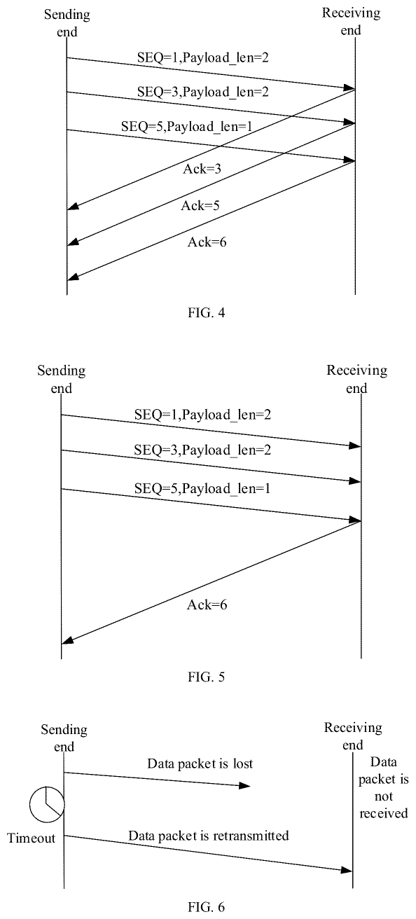

It may be learned that the sending end shown in FIG. 3 continues to send a subsequent data packet after receiving the acknowledgment message, which is referred to as stop-and-wait ARQ (automatic repeat request). In actual application, the sending end may continuously send a plurality of data packets without receiving the acknowledgment message. FIG. 4 is a schematic diagram of another sending process of a TCP data packet according to an embodiment of the present disclosure. As shown in FIG. 4, the sending end continuously sends three data packets: packet sequence numbers SEQ are 1, 3, and 5 respectively, and payload lengths Payload_len are 2, 2, and 1 respectively, and does not wait for receiving a corresponding acknowledgment message before sending a subsequent data packet. Correspondingly, each time the receiving end receives one data packet, the receiving end replies with an acknowledgment message for the data packet. The acknowledgment message shown in FIG. 4 is the same as the acknowledgment message shown in FIG. 3, and details are not described herein again.

It may be learned that the sending end shown in FIG. 4 continuously sends data packets without receiving the acknowledgment message, which is referred to as continuous ARQ. In some scenarios, the receiving end may further reduce a quantity of replied acknowledgment messages, which is referred to as continuous ARQ-cumulative Ack. FIG. 5 is a schematic diagram of another sending process of a TCP data packet according to an embodiment of the present disclosure. As shown in FIG. 5, similar to FIG. 4, the sending end continuously sends three data packets. Different from FIG. 4, the receiving end replies with an acknowledgment message to the sending end after receiving the three data packets, to indicate, by using an Ack, that data before a data sequence number 6 has been received by the sending end.

In the foregoing data packet transmission process, to send the data packet from the sending end to the receiving end, the data packet needs to pass through a plurality of forwarding nodes. In such a long transmission link, it is very likely that data packets are lost. Therefore, a retransmission mechanism is an important implementation of transmission reliability. When the sending end considers that a sent data packet is lost, that is, the data packet is not received by the receiving end, the sending end re-sends the same data packet. The sending end may determine, according to the foregoing acknowledgment message, which data packets need to be retransmitted.

The foregoing retransmission includes two types: timeout retransmission and fast retransmission.

Timeout retransmission means that after sending a data packet, a sending end starts a timer, and retransmits the data packet when an acknowledgment message replied by a receiving end is not received before the timer expires. FIG. 6 to FIG. 8 are schematic diagrams of three timeout retransmission processes of a data packet according to embodiments of the present disclosure.

As shown in FIG. 6, after the sending end sends the data packet, the data packet is lost and does not reach the receiving end, and the receiving end does not receive the data packet. Therefore, the receiving end does not reply with an acknowledgment message to the sending end. In this scenario, the sending end retransmits the data packet when the timer expires.

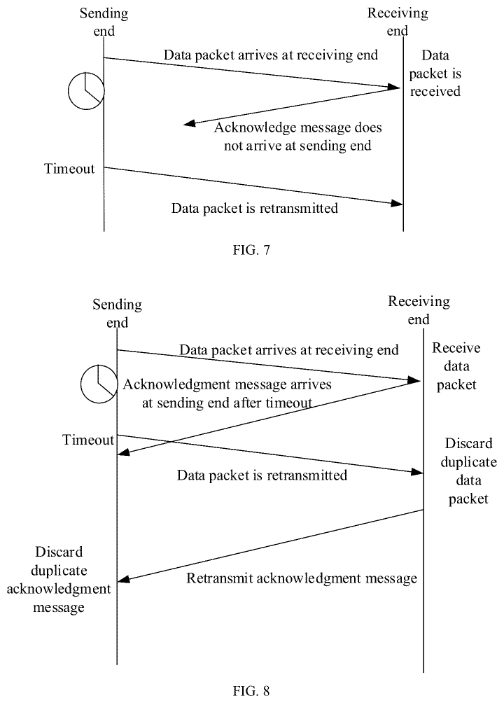

As shown in FIG. 7, the data packet reaches the receiving end, so that the receiving end receives the data packet, but an acknowledgment message replied by the receiving end to the sending end does not reach the sending end. In this scenario, the sending end retransmits the data packet when the timer expires.

As shown in FIG. 8, the data packet reaches the receiving end, so that the receiving end receives the data packet. An acknowledgment message replied by the receiving end to the sending end expires when reaching the sending end. Therefore, the data packet is retransmitted before the sending end receives the acknowledgment message. When receiving the retransmitted data packet, the receiving end discards the duplicate data packet, and sends a retransmission acknowledgment message to the sending end. The retransmission acknowledgment message is duplicated with the previous acknowledgment message. Therefore, the sending end discards the duplicate acknowledgment message.

It may be learned from foregoing FIG. 6 to FIG. 8 that regardless of whether the data packet is lost or the acknowledgment message is lost or expires, the sending end retransmits the data packet when the timer expires.

For fast retransmission, it means that before a timer of a sending end expires, the sending end continuously receives a plurality of acknowledgment messages, and may determine a missing data packet according to the acknowledgment messages, to retransmit the data packet before the timer expires.

It may be understood that when a small amount of retransmissions occur, it indicates high transmission reliability, and such retransmissions are normal. When a large amount of retransmissions occur, it indicates poor transmission reliability, which may result in low interaction efficiency of a service system, or even unresponsiveness of the service system. Therefore, a retransmission situation is an important indicator in a data transmission scenario.

In some technologies, sequence numbers of all data packets are recorded for analysis to obtain the retransmission situation. For example, a header of a forwarded data packet is sent to a big data platform for storage and offline analysis of the sequence numbers to obtain the retransmission situation, or a receive window may be used to store packet sequence numbers of received data packets, and a red-black tree may be used to store packet sequence numbers of out-of-order data packets, for analysis to obtain the retransmission situation. In addition, received packet sequence numbers may be stored in a bitmap manner for analysis to obtain the retransmission situation.

However, all the foregoing methods need to record sequence numbers of all historical data packets, resulting in large occupied storage space. In addition, analysis based on sequence numbers of all data packets has a problem of a large amount of calculation, which further results in an increase in a processing duration of data packets and a reduction in a forwarding efficiency of data packets.

To solve the foregoing problems, in the embodiments of the present disclosure, an expected packet sequence number may be recorded to indicate an expected data packet to be received before a data packet arrives. In this way, retransmission detection may be performed based on the expected packet sequence number, a received current packet sequence number, and a current packet type. Compared with a case of recording identifiers of all data packets, less information is recorded in the embodiments of the present disclosure, thereby reducing occupied storage space. In addition, based on less information, an amount of calculation in the embodiments of the present disclosure is small, which can effectively reduce a processing duration of data packets and improve a forwarding efficiency of data packets.

Based on the foregoing beneficial effects, the retransmission detection method in the embodiments of the present disclosure may be applied to a forwarding network element, to improve a forwarding efficiency as much as possible. The forwarding network element is any network element used to forward data packets, and is a network element between a sending end and a receiving end. In some examples, the retransmission detection method in the embodiments of the present disclosure may be applied to a forwarding network element of a cloud network.

FIG. 9 is a schematic diagram of a data forwarding process based on a cloud network according to an embodiment of the present disclosure. As shown in FIG. 9, data forwarding depends on the cloud network and a physical network. The cloud network includes but is not limited to a VSwitch (virtual switch) and a forwarding network element. The forwarding network element includes but is not limited to a NAT (network address translation) network element, a privatelink (private link) network element, a LB (load balance) network element, and a VPN (virtual private network) network element. The physical network includes but is not limited to a switch. FIG. 9 exemplarily shows VSwitches: VSwitch1 and a VSwitch2, and two switches: A1 and A2.

As shown in FIG. 9, an ECS (elastic compute service) 1 is used as a sending end, and an ECS 2 is used as a receiving end. A data transmission process between the two may include: The ECS 1 sends a data packet to a switch A1 by using the VSwitch 1, the switch A1 sends the data packet to a switch A2 by using forwarding network elements such as a NAT network element, a privatelink network element, an LB network element, and a VPN network element for forwarding, and the switch A2 sends the data packet to the receiving end ECS 2 by using the VSwitch 2.

It may be understood that any network element in foregoing FIG. 9 may use the retransmission detection method in the embodiments of the present disclosure, especially a network element of the cloud network.

The following uses specific embodiments to describe the technical solutions in the embodiments of the present disclosure and how the technical solutions in the embodiments of the present disclosure solve the foregoing technical problems in detail. The following specific embodiments may be combined with each other, and for the same or similar concepts or processes, some embodiments may not be described again. The embodiments of the present disclosure will be described below with reference to the accompanying drawings.

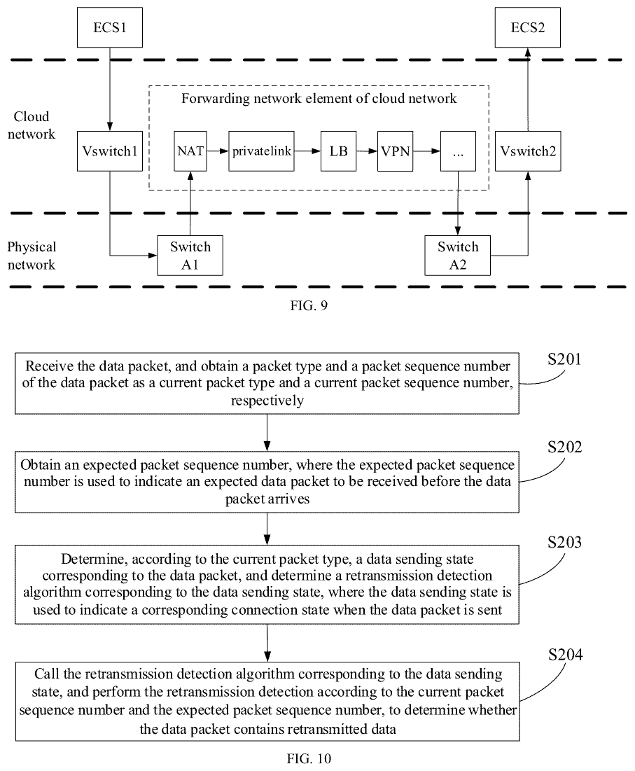

FIG. 10 is a flowchart of steps of a method for retransmission detection of a data packet according to an embodiment of the present disclosure. As shown in FIG. 10, the method for retransmission detection of a data packet includes the following steps.

S201: receive the data packet, and obtain a packet type and a packet sequence number of the data packet as a current packet type and a current packet sequence number, respectively.

The current packet type is a packet type of the received data packet, and may include but is not limited to a connection establishment data packet, a disconnected data packet, and a connected data packet. The packet type may be obtained from a header of the data packet. A specified bit in the header of the data packet is provided with a flag bit of the packet type. For example, a B1th bit in the header is used to indicate whether the data packet is a connection establishment data packet. When the B1th bit is 1, it indicates that the data packet is a connection establishment data packet. Otherwise, the data packet is not a connection establishment data packet. Similarly, a B2th bit is used to indicate whether the data packet is a disconnected data packet. When the data packet is neither the disconnected data packet nor the connection establishment data packet, it may be considered that the data packet is the connected data packet.

The current packet sequence number is a packet sequence number of the received data packet, and may be obtained from a header of the data packet. The current packet sequence number is located at a specified bit of the data packet. The packet sequence number may be represented by a preset number of digits, for example, may be represented by 32 digits.

S202: obtain an expected packet sequence number, where the expected packet sequence number is used to indicate an expected data packet to be received before the data packet arrives.

The expected packet sequence number is continuously updated according to the received data packets, and specifically may be updated according to a packet sequence number and a payload length of the received data packet. The expected packet sequence number is initially set to 0. For example, when a TCP connection is in a disconnected state or a connection establishment state, if a data packet with a packet sequence number of C1 and a payload length of C2 is received, the expected packet sequence number may be updated to C1+C2+1, to expect that a packet sequence number of a next received data packet is C1+C2+1. When the TCP connection is in a connected state, if a data packet with a packet sequence number of C1 and a payload length of C2 is received, the expected packet sequence number may be updated to C1+C2, to expect that a packet sequence number of a next received data packet is C1+C2.

The payload length is a length of user data in the data packet, and may be calculated according to information in the header of the data packet. For example, for an IPv4 (Internet protocol version 4) data packet, a payload length may be obtained by subtracting an IPv4 header length and a TCP header length from a total length of the data packet in the header. For an IPv6 (Internet protocol version 6) data packet, the foregoing payload length may be obtained by subtracting an option length of the IPv6 and the TCP header length from an IPv6 payload length in the header.

In the embodiments of the present disclosure, a variable needs to be set to store the expected packet sequence number. Compared with a large quantity of packet sequence numbers, the expected packet sequence number occupies less storage space.

S203: determine, according to the current packet type, a data sending state corresponding to the data packet and determine a retransmission detection algorithm corresponding to the data sending state, where the data sending state is used to indicate a corresponding connection state when the data packet is sent.

It may be understood that different current packet types correspond to different data sending states, different data sending states correspond to different retransmission detection algorithms, and different retransmission detection algorithms use different parameters and retransmission detection logics. For example, when the current packet type is the connected data packet, it indicates that the data sending state is the connected state. In this case, the retransmission detection algorithm corresponding to the connected state may be called for the retransmission detection. When the current packet type includes the connection establishment data packet or the disconnected data packet, it indicates that the data sending state is the connection establishment state or the disconnected state. In this case, the retransmission detection algorithm corresponding to the connection establishment state or the disconnected state needs to be called for retransmission detection.

In the embodiments of the present disclosure, different retransmission detection algorithms may be designed for different data sending states, which helps improve retransmission detection accuracy.

In some implementations, the current packet type includes at least one of the following: the connected data packet, the disconnected data packet, and the connection establishment data packet; the data sending state includes at least one of the following: the connected state, the disconnected state, and the connection establishment state; the connected state and the disconnected state correspond to different retransmission detection algorithms; and the connection establishment state and the disconnected state correspond to a same retransmission detection algorithm.

It may be understood that different current packet types may correspond to different data sending states, and different data sending states may correspond to different retransmission detection algorithms. However, for each received data packet, the data packet corresponds to one packet type. Therefore, for the data packet, one data sending state and one retransmission detection algorithm may be uniquely determined according to the current packet type.

S204: call the retransmission detection algorithm corresponding to the data sending state, and perform the retransmission detection according to the current packet sequence number and the expected packet sequence number, to determine whether the data packet contains retransmitted data.

In an example, if a current packet sequence number of a received data packet is less than the expected packet sequence number, it may be considered that the received data packet contains retransmitted data, and a retransmission statistics result is updated. Otherwise, it is considered that the data packet does not contain retransmitted data. The data packet contains retransmitted data may include two cases: the data packet contains only retransmitted data, or the data packet contains the retransmitted data and new data. The updating the retransmission statistics result includes but is not limited to: increasing a number of retransmissions by 1, and determining an updated retransmission rate according to the updated number of retransmissions.

However, the foregoing retransmission detection strategy is not accurate because a packet sequence number mechanism is different in different phases. To improve accuracy, the embodiments of the present disclosure may implement retransmission detection in combination with a current packet type, to determine a data sending state by using the current packet type, and use different retransmission detection mechanisms in different data sending states.

When a current connection state is the disconnected state or the connection establishment state, foregoing S203 includes S2031, and correspondingly, foregoing S204 includes S2041, to perform retransmission detection in combination with the current packet sequence number and the expected packet sequence number. When the current connection state is the connected state, S203 includes S2032, and correspondingly, foregoing S204 includes S2042, to perform retransmission detection in combination with the current packet sequence number, the expected packet sequence number, and a hole length. The implementation processes of foregoing S2031 and S2032 and those of S2041 and S2042 are described in detail below.

S2031: if the current packet type satisfies a first preset condition, or the current packet type and the expected packet sequence number satisfy a second preset condition, determine that the data sending state is the disconnected state or the connection establishment state. The first preset condition includes that the current packet type is a disconnected data packet, and the second preset condition includes that the current packet type includes a connection establishment data packet, and the expected packet sequence number is not an initial packet sequence number.

Correspondingly, S2041: call a retransmission detection algorithm corresponding to the disconnected state or the connection establishment state, and perform the retransmission detection according to whether the current packet sequence number is the same as the expected packet sequence number.

It may be learned from foregoing S2031 that if the current packet type is the disconnected data packet, it indicates that the current connection state is the disconnected state. In this case, retransmission detection may be directly performed according to whether the current packet sequence number is the same as the expected packet sequence number. If the current packet type is the connection establishment data packet, it indicates that the current connection state is the connection establishment state. In this case, it is further necessary to determine whether the expected packet sequence number is the initial packet sequence number. When the expected packet sequence number is not the initial packet sequence number, retransmission detection is performed according to whether the current packet sequence number is the same as the expected packet sequence number. In contrast, when the expected packet sequence number is the initial packet sequence number, it indicates that the data packet is a first connection establishment data packet, and retransmission detection does not need to be performed.

Specifically, the foregoing performing the retransmission detection according to whether the current packet sequence number is the same as the expected packet sequence number includes: if the current packet sequence number is the same as the expected packet sequence number, determining that the received data packet contains retransmitted data; otherwise, determining that the received data packet does not contain retransmitted data.

It should be noted that when the current packet type includes the foregoing disconnected data packet or the foregoing connection establishment data packet, it indicates that the current connection state is the connection establishment state or the disconnected state. In this case, the expected packet sequence number may be updated according to the current packet sequence number, a payload length of the data packet, and a preset sequence number offset. The updated expected packet sequence number may be the sum of the current packet sequence number of the received data packet, the payload length of the data packet, and the preset sequence number offset. In the TCP protocol, the preset sequence number offset may be 1.

S2032: if the current packet type is the connected data packet, it indicates that the data sending state is the connected state. The connected state includes at least one of the following: an out-of-order state, an overlapping state, and a wraparound state. The out-of-order state is used to indicate that an order in which data packets arrive at a receiving end is inconsistent with an order in which a sending end sends the data packets, the overlapping state is used to indicate that retransmitted data and expected data are concurrently present in a data packet, and the wraparound state is used to indicate that when a packet sequence number of a data packet reaches a maximum value, numbering starts again from a minimum value.

Correspondingly, S2042: obtain a hole length, and call the retransmission detection algorithm corresponding to the connected state, and perform retransmission detection according to the current packet sequence number, the expected packet sequence number, and the hole length. The hole length is used to indicate a length of missing data. Therefore, in combination with the hole length, it may be determined whether the received data packet is the missing data, thereby facilitating retransmission detection and helping improve retransmission detection accuracy in the connected state.

The connected state may include at least one sub-state. Therefore, foregoing S2042 may include S20421 and S20422.

S20421: determine the sub-state according to the current packet sequence number and the expected packet sequence number. The sub-state is one of the following: the out-of-order state, the overlapping state, and the wraparound state. The out-of-order state is used to indicate that the data packet does not arrive in an order of packet sequence numbers, the overlapping state is used to indicate that the data packet contains both the retransmitted data and data to be transmitted, and the wraparound state is used to indicate that a packet sequence number wraps around during transmission of the data packet.

S20422: call a retransmission detection algorithm corresponding to the sub-state, and perform the retransmission detection according to the current packet sequence number, the expected packet sequence number, and the hole length.

The embodiments of this application may further divide the connected state into a plurality of sub-states in combination with the foregoing current packet sequence number and expected packet sequence number, to call a corresponding retransmission detection algorithm to implement the retransmission detection. In this way, the retransmission detection may be further implemented more accurately.

Specifically, if the current packet sequence number is greater than or equal to the expected packet sequence number, it may be determined that the received data packet does not contain retransmitted data. Alternatively, it may be further determined whether there is retransmitted data in combination with the hole length. If the current packet sequence number is less than the expected packet sequence number, S20421 further includes S204211, and S20422 further includes S204221 to S204223. S204211 is used to determine the sub-state, and S204221 to S204223 are used to determine, in combination with the hole length, whether the received data packet contains retransmitted data. If a data length, in the data packet, that is located before the expected packet sequence number is greater than the hole length, it may be determined that the data packet contains retransmitted data. Otherwise, it may be considered that the data packet does not contain retransmitted data.

S204211: if the current packet sequence number is less than the expected packet sequence number, determine that the sub-state is the out-of-order state or the overlapping state.

It may be understood that when it is determined, by using S204211, that the sub-state is the out-of-order state or the overlapping state, S204221 to S204223 are retransmission detection in the out-of-order state or the overlapping state.

S204221: determine, according to the current packet sequence number, a payload length of the received data packet, and the expected packet sequence number, a length of first data in the data packet that is located before the expected packet sequence number.

The foregoing length of the first data is a data length, in the received data packet, that is located before the expected packet sequence number. The lengths of the first data are different in the following two cases: the expected packet sequence number being less than or equal to an end data sequence number of the received data packet, or the expected packet sequence number being greater than the end data sequence number of the received data packet. The end data sequence number is the current packet sequence number plus the payload length of the data packet minus 1.

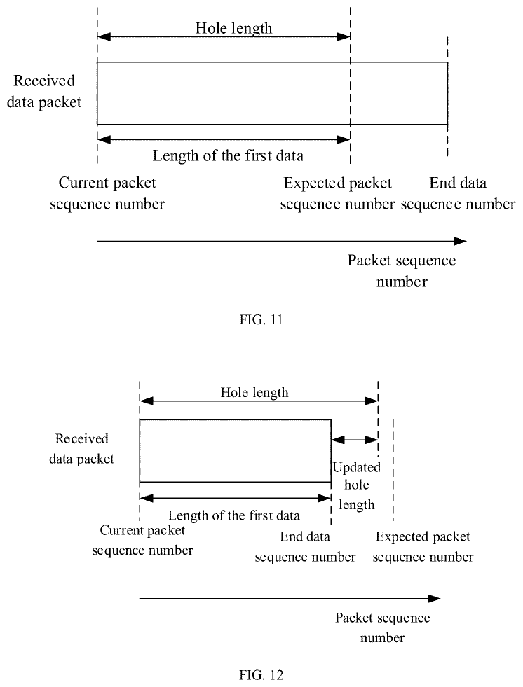

FIG. 11 and FIG. 12 are schematic diagrams of a length of first data in two cases according to an embodiment of the present disclosure. In FIG. 11 and FIG. 12, packet sequence numbers increase from left to right.

As shown in FIG. 11, the end data sequence number of the received data packet is greater than the expected packet sequence number. In this case, a data length, in the data packet, that is located before the expected packet sequence number is the length of the first data. It indicates that the received data packet is an overlapping data packet that arrives in order. It may be considered that the data sending state is the overlapping state.

As shown in FIG. 12, the end data sequence number of the received data packet is less than the expected packet sequence number. In this case, the payload length of the data packet is the length of the first data. It indicates that the received data packet is an out-of-order data packet. It may be considered that the data sending state is the out-of-order state.

It may be understood that in some scenarios, data packets may arrive out of order. For example, three data packets are sequentially received: {SEQ=1, Payload_len=1}, {SEQ=3, Payload_len=1}, and {SEQ=2, Payload_len=1}. After the second data packet is received, the expected packet sequence number is set to 4. Therefore, when the third data packet is received, if retransmission detection is simply performed by using a packet sequence number increment manner, the third data packet may be mistakenly determined as a retransmitted data packet. In the embodiments of the present disclosure, retransmission detection may be performed in combination with the hole length. When the current packet sequence number of the received data packet is less than the expected packet sequence number, it is further determined whether the data packet is a retransmitted data packet by using the hole length. In this way, it can be avoided that an out-of-order data packet is mistakenly determined as a retransmitted data packet, thereby helping improve retransmission detection accuracy.

In addition, when the current packet sequence number of the received data packet is greater than the expected packet sequence number, the hole length needs to be expanded, indicating that an increase in missing data. The received data packet may be understood as a skipped data packet.

S204222: if the length of the first data is greater than the hole length, determine that the data packet contains the retransmitted data, and update the hole length to 0, indicating that the received data packet has completed the missing data.

S204223: if the length of the first data is less than or equal to the hole length, determine that in the out-of-order state or the overlapping state, the data packet does not contain the retransmitted data. In this case, the hole length is decreased according to the length of the first data.

The updated hole length is the hole length before the update minus the length of the first data, to indicate that data, in the received data packet, that is located before the expected packet sequence number compensates for some missing data. As shown in FIG. 11, in the overlapping state, when the length of the first data is equal to the hole length in FIG. 11, the updated hole length is 0, indicating that all the missing data has been completed. As shown in FIG. 12, in the out-of-order state, when the length of the first data is less than the hole length, the length of the first data may decrease the hole length. The updated hole length is shown in FIG. 12, indicating that some missing data is completed.

The embodiments of the present disclosure can update the hole length according to the length of the first data and the hole length, which can improve the accuracy of the hole length, thereby improving the accuracy of retransmission detection.

In some other implementations, foregoing S20422 may further include S204224, to update the expected packet sequence number by using S204224.

S204224: if the current packet sequence number is less than the expected packet sequence number, and an end data sequence number of the data packet is greater than the expected packet sequence number, it indicates that the received data packet is an overlapping data packet that arrives in order. It may be considered that the data sending state is the overlapping state. In this case, the expected packet sequence number needs to be updated according to the payload length of the data packet and the current packet sequence number. As shown in FIG. 11, the updated expected packet sequence number is a sum of the current packet sequence number and the payload length, that is, the end data sequence number in FIG. 11.

It should be noted that when the current packet sequence number is less than the expected packet sequence number, if the end data sequence number of the data packet is less than the expected packet sequence number, it indicates that the received data packet is an out-of-order data packet. It is considered that the data sending state is the out-of-order state, and the arrival of the data packet does not need to update the expected packet sequence number.

The embodiments of the present disclosure can identify the out-of-order state and the overlapping state, to accurately update the expected packet sequence number, thereby helping further improve retransmission detection accuracy.

In conclusion, foregoing S204221 to S204224 describe a retransmission detection process, a hole length update process, and an expected packet sequence number update process when the current packet sequence number is less than the expected packet sequence number. The following describes a retransmission detection process, a hole length update process, and an expected packet sequence number update process when the current packet sequence number is greater than the expected packet sequence number.

In some implementations, foregoing S20421 may further include S204212, and S20422 may further include S204225 to S204227, to perform the retransmission detection process when the current packet sequence number is greater than the expected packet sequence number by using S204225 and S204227.

S204212: if the current packet sequence number is greater than the expected packet sequence number, and a difference between the current packet sequence number and the expected packet sequence number is greater than or equal to a preset threshold, determine that the sub-state is the wraparound state.

It may be understood that when it is determined, by using S204212, that the sub-state is the wraparound state, S204225 to S204227 are used for retransmission detection in the wraparound state.

S204225: obtain, from the data packet a length of second data that is located before the expected packet sequence number and that is located after the current packet sequence number.

S204226: if the length of the second data is greater than the hole length, determine that the foregoing data packet contains the retransmitted data, and update the hole length to 0.

The wraparound state means that in a process in which a sending end sends data packets one by one in order, the sending end continuously increases a packet sequence number of the data packets. When the packet sequence number of the data packet reaches a preset packet sequence number, the sending end numbers the packet sequence number again from an initial packet sequence number. For example, the packet sequence number is represented by 32 bits, the initial packet sequence number is 0, and the preset packet sequence number may be 2\hat{ }32−1. Therefore, when the packet sequence number reaches 2\hat{ }32−1, the sending end numbers the packet sequence number again from 0. Wraparound is continuously performed in this way.

When the sub-state is not the wraparound state, a retransmitted packet sequence number is less than the expected packet sequence number. When the sub-state is not the wraparound state, the retransmitted packet sequence number may be greater than the expected packet sequence number. In addition, based on the foregoing sequence number wraparound mechanism, when the current packet sequence number is greater than the expected packet sequence number, directly determining that the received data packet does not contain the retransmitted data may be inaccurate, resulting in low retransmission detection accuracy. To further improve retransmission detection accuracy, in the embodiments of the present disclosure, when the current packet sequence number is greater than the expected packet sequence number, it is further determined whether a sequence number wraparound occurs, to determine that the received data packet does not contain the retransmitted data when the sequence number wraparound does not occur, and implement retransmission detection by using foregoing S204225 to S204227 when the sequence number wraparound occurs.

In some implementations, when the current packet sequence number is greater than the expected packet sequence number, foregoing S204212 may determine whether a sequence number wraparound occurs by using the following steps: if a difference between the current packet sequence number and the expected packet sequence number is greater than or equal to a preset threshold, determine that the data sending state is the wraparound state. Otherwise, determine that the sub-state is not the wraparound state.

The preset threshold is a value determined based on experience. For example, it is learned based on experience that the preset threshold may be 2\hat{ }30. In other words, it is learned based on experience that when the difference between the current packet sequence number and the expected packet sequence number is greater than or equal to 2\hat{ }30, it is determined that a sequence number wraparound occurs. The embodiments of the present disclosure may determine whether a sequence number wraparound occurs in combination with a plurality of dimensions such as the current packet sequence number, the expected packet sequence number, and the preset threshold, to improve accuracy of determining whether the sequence number wraparound occurs.

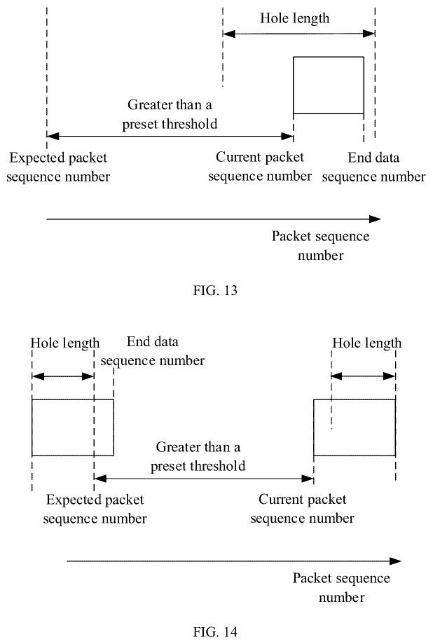

FIG. 13 is a schematic diagram of a sequence number wraparound scenario according to an embodiment of the present disclosure. As shown in FIG. 13, when a data packet is received, a current packet sequence number of the data packet is greater than an expected packet sequence number, and a difference between the current packet sequence number and the expected packet sequence number is greater than a preset threshold. Therefore, it is considered that a sequence number wraparound occurs. In addition, because an end data sequence number of the data packet is greater than the current packet sequence number, the received data packet contains only data before sequence number wraparound. In this case, the length of the second data is equal to a payload of the data packet. Because the hole length is greater than the length of the second data, it is determined that the data packet in the wraparound state does not contain retransmitted data. Certainly, if the hole length is less than or equal to the length of the second data, it is considered that the data packet in the wraparound state contains retransmitted data.

FIG. 14 is a schematic diagram of another sequence number wraparound scenario according to an embodiment of the present disclosure. As shown in FIG. 14, when a data packet is received, a current packet sequence number of the data packet is greater than an expected packet sequence number, and a difference between the current packet sequence number and the expected packet sequence number is greater than a preset threshold. Therefore, it is considered that a sequence number wraparound occurs. In addition, because an end data sequence number of the data packet is greater than the expected packet sequence number, it is determined that the received data packet contains data before sequence number wraparound and data after sequence number wraparound. In this case, a length of second data, before the expected packet sequence number and after the current packet sequence number, may be obtained from the data packet. As shown in FIG. 14, the length of the second data is greater than a sum of lengths of two parts of hole, and it is determined that the data packet contains retransmitted data. Certainly, if the length of the first data is less than the hole length, it is considered that the data packet does not contain retransmitted data.

FIG. 15 is a schematic diagram of another sequence number wraparound scenario according to an embodiment of the present disclosure. As shown in FIG. 15, the current packet sequence number is less than the expected packet sequence number, so that lengths of two new parts of hole are increased. In this case, the current packet sequence number needs to be used as the updated expected packet sequence number.

S204227: if the length of the second data is less than or equal to the hole length, it may be determined that the data packet does not contain retransmitted data. In addition, the hole length is decreased according to the length of the second data, indicating that the received data packet fills some missing data. In this way, the hole length when the sequence number wraparound occurs may be further improved, thereby improving retransmission detection accuracy.

In some other implementations, foregoing S20422 may further include S204228, to update the hole length and the expected packet sequence number by using S204228.

S204228: when the current packet sequence number is greater than the expected packet sequence number, and a difference between the current packet sequence number and the expected packet sequence number is less than the preset threshold, the sub-state is not the wraparound state, and it is considered that the received data packet does not contain retransmitted data. However, the hole length needs to be increased according to the difference between the current packet sequence number and the expected packet sequence number, and the expected packet sequence number needs to be updated according to the current packet sequence number and a payload length of the data packet. The updated expected packet sequence number is a sum of the current packet sequence number and the payload length of the data packet.

It may be understood that in the embodiments of the present disclosure, when the current packet sequence number is greater than the expected packet sequence number, and a difference between the current packet sequence number and the expected packet sequence number is less than or equal to the preset threshold, it is determined that a sequence number wraparound does not occur. In this case, it is determined that the received data packet does not contain retransmitted data. However, because the current packet sequence number of the received data packet is after the expected packet sequence number, it indicates that new missing data occurs. Therefore, the hole length and the expected packet sequence number need to be updated. Update of the hole length and the expected packet sequence number when a wraparound does not occur is implemented, which helps improve accuracy of the hole length and the expected packet sequence number, thereby improving retransmission detection accuracy.

In conclusion, S20421 and S20422 respectively describe retransmission detection processes when a current connection state is the connection establishment/disconnected state and the connected state. The retransmission detection of the data packet may be implemented according to S20421 and S20422. However, considering that in the connected state, a connection may support a probe data packet, to implement a probe function in the connected state. For example, for the TCP protocol, it has an active probe function, including but not limited to: keepalive probe, zero-window probe, maximum transmission unit (MTU) probe, and tail loss probe. After the zero-window probe, a zero-window recovery function is further provided.

For the foregoing probe function, a packet sequence number of a data packet used is usually unchanged, but a packet sequence number of a probe packet may be less than or equal to an expected packet sequence number. Therefore, the retransmission detection method may mistakenly consider these data packets as retransmitted data packets, thereby resulting in low retransmission detection accuracy.

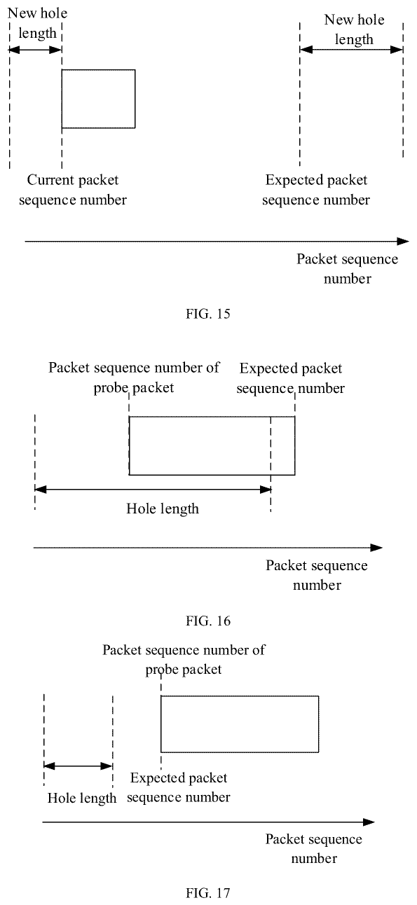

FIG. 16 and FIG. 17 are schematic diagrams of two relationships between a packet sequence number of a probe packet, a hole length, and an expected packet sequence number according to two embodiments of the present disclosure.

As shown in FIG. 16, a packet sequence number of a probe packet is less than an expected packet sequence number, an end data sequence number of the probe packet is less than or equal to the expected packet sequence number, and a payload length of the probe packet is less than the hole length. In this case, the probe packet is mistakenly determined as a retransmitted data packet in an out-of-order state.

As shown in FIG. 17, a packet sequence number of a probe packet is the same as an expected packet sequence number. In this case, the probe packet is mistakenly determined as an in-order data packet in an in-order state without combining a hole length, to update the expected packet sequence number.

To improve retransmission detection accuracy, in some implementations, before performing the retransmission detection according to the current packet sequence number, the expected packet sequence number, and the hole length in foregoing S20422, S20423 and S20424 may further be used to filter out data packets related to some probe functions and a zero-window recovery function, to determine that the data packets do not contain retransmitted data.

S20423: determine whether the received data packet is a target data packet. The target data packet includes at least one of the following: a keepalive probe packet, a zero-window probe packet, and a zero-window recovery packet.

S20424: if the data packet is the target data packet, determine that the data packet does not contain the retransmitted data.

It may be understood that for the foregoing maximum transmission unit probe function, data used in a corresponding maximum transmission unit probe data packet is data to be sent. Therefore, the data does not need to be filtered out.

For the foregoing tail loss probe function, data used in a corresponding tail loss probe data packet is data to be sent or data that has been successfully sent. When the used data is data to be sent, the data does not need to be filtered out. When the used data is data that has been successfully sent, the retransmission detection may also be performed by using S20422 in the embodiments of the present disclosure, and filtering out does not need to be performed in advance.

For the foregoing keepalive probe function, a corresponding keepalive probe packet uses a used packet sequence number, but does not contain retransmitted data. Therefore, the keepalive probe packet needs to be filtered out in advance.

For the foregoing zero-window probe function, a corresponding zero-window probe packet uses a used packet sequence number or an unused packet sequence number, but does not contain retransmitted data. Therefore, the zero-window probe packet also needs to be filtered out in advance.

For the foregoing zero-window recovery function, after zero-window recovery is performed, a packet sequence number of a data packet sent by a sending end is special, is not the retransmitted data, and an expected packet sequence number needs to be updated. Therefore, it also needs to be filtered out in advance.

In some implementations, foregoing S20423 may include S204231 and S204232, to specifically identify the target data packet.

S204231: obtain a receive window length, where the receive window length is used to indicate a length of data currently receivable by a receiving end.

S204232: determine whether the data packet is the target data packet according to a payload length of the data packet, the current packet sequence number, the expected packet sequence number, and the receive window length.

The receive window length may be determined based on information included in an acknowledgment message that is replied by the receiving end to the sending end.

In a transport layer protocol, to distinguish a zero-window probe packet and a zero-window recovery packet from a service data packet, different settings are performed on the zero-window probe packet, the zero-window recovery packet and the service data packet in terms of a payload length and a packet sequence number. In other words, a payload length of the zero-window probe packet, a payload length of the zero-window recovery packet, and a payload length of the service data packet are different, and/or a packet sequence number of the zero-window probe packet, a packet sequence number of the zero-window recovery packet, and a packet sequence number of the service data packet are different. In addition, in the protocol, the zero-window probe packet, the zero-window recovery packet, and the service data packet may also be distinguished by using the receive window length.

It should be noted that different protocols may flexibly set a data packet distinguishing strategy based on a packet sequence number, a payload length, and a receive window length. This is not limited in the embodiments of the present disclosure.

It can be seen that in the embodiments of the present disclosure, the target data packet may be identified in combination with the receive window length, the payload length, and the expected packet sequence number, thereby improving accuracy of identifying the target data packet by using as many dimensions as possible.

In some implementations, foregoing S204232 may further include S2042321 to S204233, to more accurately identify the target data packet.

S2042321: if a payload length of the received data packet is within a first length range, and the current packet sequence number and the expected packet sequence number satisfy a first preset relationship, determine that the data packet is a keepalive probe packet.

S2042322: if a payload length of the received data packet is within a second length range, and the current packet sequence number and the expected packet sequence number satisfy a second preset relationship, and a receive window length is within a third length range, determine that the data packet is a zero-window probe packet.

S2042323: if a payload length of the received data packet is not within the first length range, the current packet sequence number and the expected packet sequence number satisfy the first preset relationship, and a zero-window probe packet is received before the data packet, determine that the data packet is a zero-window recovery packet.

The first length range, the first preset relationship, the second length range, the second preset relationship, and the third length range may all be set according to a protocol. For example, in the TCP protocol, the foregoing first length range may be that the payload length is 0 or 1, the second length range is 1, the first preset relationship is that the current packet sequence number is equal to the expected packet sequence number minus 1, the second preset relationship may be that the current packet sequence number is equal to the expected packet sequence number, and the third length range is 0.

To determine the zero-window recovery packet, a pre-recorded probe flag probe may be used. The probe flag is set to a first value after S2042322 is performed, and is set to a second value after S2042323 is performed. For example, the first value may be true, and the second value may be false.

In the embodiments of the present disclosure, the target data packet may be identified in combination with a plurality of different length ranges and a plurality of different preset relationships. The length range and the preset relationship may be set according to a protocol.

It can be learned from the foregoing description that in the embodiments of the present disclosure, the expected packet sequence number needs to be updated in three cases.

In a first case, the current connection state is the connection establishment/disconnected state. In this case, the expected packet sequence number may be updated according to the current packet sequence number, a payload length of the data packet, and a preset sequence number offset. For a specific update process, refer to the foregoing description of S2041.

In a second case, the current connection state is the connected state. In this case, the expected packet sequence number is updated by using S204224 when the current packet sequence number of the data packet is less than the expected packet sequence number, and an end data sequence number of the data packet is greater than the expected packet sequence number. In other words, in the connected state, when the received data packet contains both expected data and retransmitted data, the expected packet sequence number needs to be updated.

In a third case, the current connection state is the connected state. In this case, the expected packet sequence number is updated by using S204228 when the current packet sequence number of the data packet is greater than the expected packet sequence number, and a difference between the current packet sequence number and the expected packet sequence number is less than the preset threshold. In other words, in the connected state, when the received data packet contains expected data and a sequence number wraparound does not occur, the expected packet sequence number needs to be updated.

In addition to the foregoing three cases, the embodiments of the present disclosure further need to update the expected packet sequence number in two cases by using the following step S20424.

S20424: if the received data packet is a zero-window recovery packet or an in-order data packet, update the expected packet sequence number according to the current packet sequence number and a payload length of the data packet. The updated expected packet sequence number is a sum of the current packet sequence number and the payload length of the data packet.

A determination condition of the zero-window recovery packet may be referred to S2042323. A determination condition of the in-order data packet is as follows: a payload length is not within the foregoing first length range, a packet type of the in-order data packet is the connected data packet, and a packet sequence number of the in-order data packet is the same as the expected packet sequence number before the update.

It may be understood that after zero-window recovery is performed, a packet sequence number of a data packet sent by a sending end is special. Therefore, after the zero-window recovery packet is received, the expected packet sequence number needs to be updated.

When the payload length is not within the foregoing first length range, it indicates that the received data packet is a service data packet. When the packet type is the connected data packet, it indicates that the current connection state is the connected state. When the packet sequence number is the same as the expected packet sequence number before the update, it indicates that the received data packet is the in-order data packet. Therefore, the in-order data packet is an expected service data packet that is received in the connected state, that is, the data sending state is the in-order state. In this case, the expected packet sequence number needs to be updated.

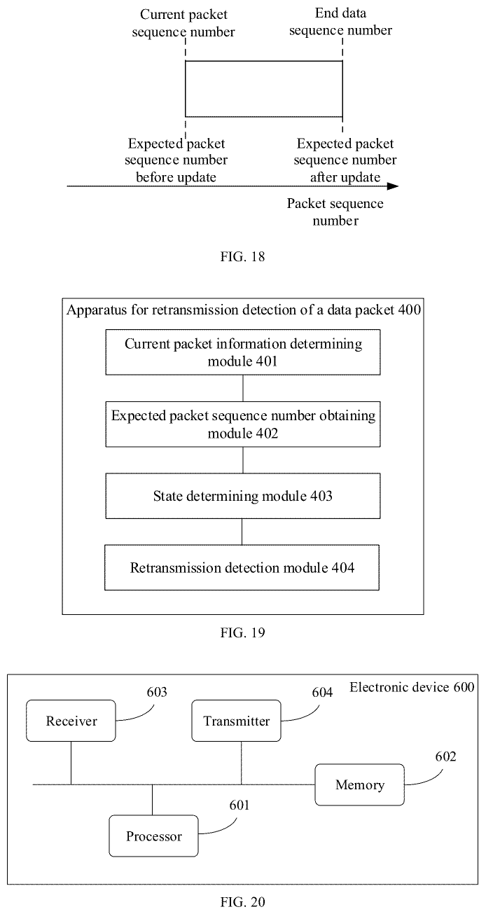

FIG. 18 is a schematic diagram of an in-order state according to an embodiment of the present disclosure. As shown in FIG. 18, in the in-order state, the current packet sequence number is the same as the expected packet sequence number before the update, and the expected packet sequence number is updated to an end data sequence number.

The embodiments of the present disclosure may further update the expected packet sequence number after zero-window recovery and update the expected packet sequence number in the in-order state, to ensure accuracy of the expected packet sequence number, thereby improving retransmission detection accuracy.

In conclusion, in the embodiments of the present disclosure, in the existing states of a TCP connection, the connected state may be further divided into the out-of-order state, the overlapping state, the wraparound state, and the in-order state. Based on this, retransmission detection may be implemented not only in the disconnected state, the connection establishment state, the out-of-order state, the wraparound state, and the in-order state, but also the expected packet sequence number and the hole length may be updated in each of the foregoing states, to ensure accuracy of the expected packet sequence number and the hole length in a retransmission detection process, thereby ensuring retransmission detection accuracy.

In the foregoing retransmission detection process, parameters such as the expected packet sequence number, the hole length, the probe flag, and the receive window length need to be used. Each transmission direction of each TCP connection has a group of such parameters. The foregoing parameters corresponding to different TCP connections and/or different transmission directions are different.

In addition, a global retransmission detection result also needs to be set to count retransmission conditions in all transmission directions of all TCP connections, and may include the foregoing number of retransmissions and retransmission rate. Certainly, a global out-of-order statistics result and/or a global wraparound statistics result and/or a global keepalive probe statistics result and/or a global zero-window probe statistics result may also be set to count out-of-order conditions, wraparound conditions, keepalive probe conditions, and zero-window probe conditions in all transmission directions of all TCP connections. The out-of-order statistics result may include but is not limited to a number of out-of-order times and an out-of-order rate, the wraparound statistics result may include but is not limited to a number of wraparound times and a wraparound rate, the keepalive probe statistics result may include but is not limited to a number of keepalive probe times and a keepalive probe rate, and the zero-window probe statistics result may include a number of zero-window probe times and a zero-window probe rate.

The foregoing retransmission detection result may be sent to a monitoring and alarm service, to perform retransmission monitoring and retransmission alarming.

Corresponding to the foregoing method for retransmission detection of a data packet, FIG. 19 is a block diagram of a structure of an apparatus for retransmission detection of a data packet according to an embodiment of the present disclosure. For ease of description, only parts related to the embodiments of the present disclosure are shown. Referring to FIG. 19, the apparatus 400 for retransmission detection of a data packet includes:
a current packet information determining module 401, configured to receive the data packet, and obtain a packet type and a packet sequence number of the data packet as a current packet type and a current packet sequence number, respectively;
an expected packet sequence number obtaining module 402, configured to obtain an expected packet sequence number, where the expected packet sequence number is used to indicate an expected data packet to be received before the data packet arrives;
a state determining module 403, configured to determine, according to the current packet type, a data sending state corresponding to the data packet, and determine a retransmission detection algorithm corresponding to the data sending state, where the data sending state is used to indicate a corresponding connection state when the data packet is sent;
a retransmission detection module 404, configured to call the retransmission detection algorithm corresponding to the data sending state, and perform the retransmission detection according to the current packet sequence number and the expected packet sequence number, to determine whether the data packet contains retransmitted data.

In an implementation, the current packet type includes at least one of the following: a connected data packet, a disconnected data packet, and a connection establishment data packet. The data sending state includes at least one of the following: a connected state, a disconnected state, and a connection establishment state. The connected state and the disconnected state correspond to different retransmission detection algorithms, and the connection establishment state and the disconnected state correspond to a same retransmission detection algorithm.

In an implementation, the state determining module 403 is further configured to:
if the current packet type is the connected data packet, determine that the data sending state is the connected state.

Correspondingly, the retransmission detection module 404 is further configured to:
obtain a hole length, and call a retransmission detection algorithm corresponding to the connected state and perform the retransmission detection according to the current packet sequence number, the expected packet sequence number, and the hole length, where the hole length is used to indicate a length of missing data.

In an implementation, the connected state includes at least one sub-state, and the retransmission detection module 404 is further configured to:
determine the sub-state according to the current packet sequence number and the expected packet sequence number, where the sub-state is one of the following: an out-of-order state, an overlapping state, and a wraparound state, the out-of-order state is used to indicate that the data packet does not arrive in a packet sequence number order, the overlapping state is used to indicate that the data packet contains both the retransmitted data and data to be transmitted, and the wraparound state is used to indicate that a packet sequence number wraps around during transmission of the data packet; and call a retransmission detection algorithm corresponding to the sub-state and perform the retransmission detection according to the current packet sequence number, the expected packet sequence number, and the hole length.

In an implementation, the retransmission detection module 404 is further configured to:
if the current packet sequence number is less than the expected packet sequence number, determine that the sub-state is the out-of-order state or the overlapping state, where the out-of-order state and the overlapping state correspond to a same retransmission detection algorithm; determine, according to the current packet sequence number, a payload length of the data packet, and the expected packet sequence number, a length of first data in the data packet that is located before the expected packet sequence number; if the length of the first data is greater than the hole length, determine that the data packet contains the retransmitted data, and update the hole length to 0; if the length of the first data is less than or equal to the hole length, determine that the data packet does not contain the retransmitted data, and decrease the hole length according to the length of the first data.

In an implementation, the retransmission detection module 404 is further configured to:
if the current packet sequence number is less than the expected packet sequence number, and an end data sequence number of the data packet is greater than or equal to the expected packet sequence number, update the expected packet sequence number according to the payload length of the data packet and the current packet sequence number.

In an implementation, the retransmission detection module 404 is further configured to:
if the current packet sequence number is greater than the expected packet sequence number, and a difference between the current packet sequence number and the expected packet sequence number is greater than or equal to a preset threshold, determine that the sub-state is the wraparound state;
obtain, from the data packet, a length of second data that is located before the expected packet sequence number and that is located after the current packet sequence number;
if the length of the second data of the data packet is greater than the hole length, determine that the data packet contains the retransmitted data, and update the hole length to 0;
if the length of the second data is less than or equal to the hole length, determine that the data packet does not contain the retransmitted data, and decrease the hole length according to the length of the second data.

In an implementation, the retransmission detection module 404 is further configured to:
if the current packet sequence number is greater than the expected packet sequence number, and a difference between the current packet sequence number and the expected packet sequence number is less than the preset threshold, determine that the sub-state is not the wraparound state, to increase the hole length according to the difference between the current packet sequence number and the expected packet sequence number, and update the expected packet sequence number according to the current packet sequence number and a payload length of the data packet.

In an implementation, the retransmission detection module 404 is further configured to:
before calling the retransmission detection algorithm corresponding to the connected state and performing the retransmission detection according to the current packet sequence number, the expected packet sequence number, and the hole length, determine whether the data packet is a target data packet, where the target data packet includes at least one of the following: a keepalive probe packet, a zero-window probe packet, and a zero-window recovery packet; and if the data packet is the target data packet, determine that the data packet does not contain retransmitted data.

In an implementation, the retransmission detection module 404 is further configured to:
obtain a receive window length, where the receive window length is used to indicate a length of data currently receivable by a receiving end; and determine whether the data packet is the target data packet according to a payload length of the data packet, the current packet sequence number, the expected packet sequence number, and the receive window length.

In an implementation, the retransmission detection module 404 is further configured to:
if the payload length of the data packet is within a first length range, and the current packet sequence number and the expected packet sequence number satisfy a first preset relationship, determine that the data packet is the keepalive probe packet; if a payload length of the data packet is within a second length range, and the current packet sequence number and the expected packet sequence number satisfy a second preset relationship, and a receive window length is within a third length range, determine that the data packet is the zero-window probe packet; if a payload length of the data packet is not within the first length range, and the current packet sequence number and the expected packet sequence number satisfy the first preset relationship, and a zero-window probe packet is received before the data packet, determine that the data packet is the zero-window recovery packet.

In an implementation, the retransmission detection module 404 is further configured to:
if the data packet is the zero-window recovery packet or an in-order data packet, update the expected packet sequence number according to the current packet sequence number and the payload length of the data packet, where a payload length of the in-order data packet is not within the first length range, a packet type of the in-order data packet is the connected data packet, and a packet sequence number of the in-order data packet is the same as the expected packet sequence number before the updating; if the current packet type includes the disconnected data packet or the connection establishment data packet, update the expected packet sequence number according to the current packet sequence number, the payload length of the data packet, and a preset sequence number offset.

In an implementation, the state determining module 403 is further configured to:
if the current packet type satisfies a first preset condition, or the current packet type and the expected packet sequence number satisfy a second preset condition, determine that the data sending state is the disconnected state or the connection establishment state, where the first preset condition includes that the current packet type is the disconnected data packet, and the second preset condition includes that the current packet type includes the connection establishment data packet, and the expected packet sequence number is not an initial packet sequence number.

Correspondingly, the retransmission detection module 404 is further configured to: call a retransmission detection algorithm corresponding to the disconnected state or the connection establishment state, and perform the retransmission detection according to whether the current packet sequence number is the same as the expected packet sequence number.

The apparatus for retransmission detection of a data packet provided in this embodiment may be configured to perform the technical solution of the method embodiment shown in FIG. 10. The implementation principles and technical effects are similar, and details are not described herein again in this embodiment.

FIG. 20 is a block diagram of a structure of an electronic device according to an embodiment of the present disclosure. The electronic device 600 includes a memory 602 and at least one processor 601.

The memory 602 stores computer-executable instructions.

The at least one processor 601 executes the computer-executable instructions stored in the memory 602, so that the electronic device 601 implements the method in FIG. 10.

In addition, the electronic device may further include a receiver 603 and a transmitter 604. The receiver 603 is configured to receive information from another apparatus or device, and forward the information to the processor 601. The transmitter 604 is configured to send information to another apparatus or device.

In a first example of the first aspect, an embodiment of the present disclosure provides a method for retransmission detection of a data packet. The method includes:
receiving the data packet, and obtaining a packet type and a packet sequence number of the data packet as a current packet type and a current packet sequence number, respectively;
obtaining an expected packet sequence number, where the expected packet sequence number is used to indicate an expected data packet to be received before the data packet arrives;
determining, according to the current packet type, a data sending state corresponding to the data packet and determining a retransmission detection algorithm corresponding to the data sending state, where the data sending state is used to indicate a corresponding connection state when the data packet is sent; and
calling the retransmission detection algorithm corresponding to the data sending state, and performing the retransmission detection according to the current packet sequence number and the expected packet sequence number, to determine whether the data packet contains retransmitted data.

Based on the first example of the first aspect, in a second example of the first aspect, the current packet type includes at least one of the following: a connected data packet, a disconnected data packet, and a connection establishment data packet. The data sending state includes at least one of the following: a connected state, a disconnected state, and a connection establishment state. The connected state and the disconnected state correspond to different retransmission detection algorithms, and the connection establishment state and the disconnected state correspond to a same retransmission detection algorithm.

Based on the second example of the first aspect, in a third example of the first aspect, the determining, according to the current packet type, the data sending state corresponding to the data packet includes:
if the current packet type is the connected data packet, determining that the data sending state is the connected state; and
the calling the retransmission detection algorithm corresponding to the data sending state, and performing the retransmission detection according to the current packet sequence number and the expected packet sequence number includes:
obtaining a hole length, and calling a retransmission detection algorithm corresponding to the connected state and performing retransmission detection according to the current packet sequence number, the expected packet sequence number, and the hole length, where the hole length is used to indicate a length of missing data.

Based on the third example of the first aspect, in a fourth example of the first aspect, the connected state includes at least one sub-state, and the calling the retransmission detection algorithm corresponding to the connected state, and performing the retransmission detection according to the current packet sequence number, the expected packet sequence number, and the hole length includes:
determining the sub-state according to the current packet sequence number and the expected packet sequence number, where the sub-state is one of the following: an out-of-order state, an overlapping state, and a wraparound state. The out-of-order state is used to indicate that the data packet does not arrive in a packet sequence number order. The overlapping state is used to indicate that the data packet contains both the retransmitted data and data to be transmitted. The wraparound state is used to indicate that a packet sequence number wraps around during transmission of the data packet; and
calling a retransmission detection algorithm corresponding to the sub-state, and performing the retransmission detection according to the current packet sequence number, the expected packet sequence number, and the hole length.

Based on the fourth example of the first aspect, in a fifth example of the first aspect, the determining the sub-state according to the current packet sequence number and the expected packet sequence number includes:
if the current packet sequence number is less than the expected packet sequence number, determining that the sub-state is the out-of-order state or the overlapping state, where the out-of-order state and the overlapping state correspond to a same retransmission detection algorithm; and
the calling the retransmission detection algorithm corresponding to the sub-state, and performing the retransmission detection according to the current packet sequence number, the expected packet sequence number, and the hole length includes:
determining, according to the current packet sequence number, a payload length of the data packet, and the expected packet sequence number, a length of first data in the data packet that is located before the expected packet sequence number;
if the length of the first data is greater than the hole length, determining that the data packet contains the retransmitted data, and updating the hole length to 0; and
if the length of the first data is less than or equal to the hole length, determining that the data packet does not contain retransmitted data, and decreasing the hole length according to the length of the first data.

Based on the fifth example of the first aspect, in a sixth example of the first aspect, the method further includes:
if the current packet sequence number is less than the expected packet sequence number, and an end data sequence number of the data packet is greater than or equal to the expected packet sequence number, updating the expected packet sequence number according to the payload length of the data packet and the current packet sequence number.

Based on the fourth example of the first aspect, in a seventh example of the first aspect, the determining the sub-state according to the current packet sequence number and the expected packet sequence number includes:
if the current packet sequence number is greater than the expected packet sequence number, and a difference between the current packet sequence number and the expected packet sequence number is greater than or equal to a preset threshold, determining that the sub-state is the wraparound state; and the calling the retransmission detection algorithm corresponding to the sub-state, and performing the retransmission detection according to the current packet sequence number, the expected packet sequence number, and the hole length includes:
obtaining, from the data packet, a length of second data that is located before the expected packet sequence number and that is located after the current packet sequence number;
if the length of the second data of the data packet is greater than the hole length, determining that the data packet contains the retransmitted data, and updating the hole length to 0;
if the length of the second data is less than or equal to the hole length, determining that the data packet does not contain the retransmitted data, and decreasing the hole length according to the length of the second data.

Based on the seventh example of the first aspect, in an eighth example of the first aspect, the method further includes:
if the current packet sequence number is greater than the expected packet sequence number, and a difference between the current packet sequence number and the expected packet sequence number is less than the preset threshold, determining that the sub-state is not the wraparound state, to increase the hole length according to the difference between the current packet sequence number and the expected packet sequence number, and update the expected packet sequence number according to the current packet sequence number and a payload length of the data packet.

Based on the third to eighth examples of the first aspect, in a ninth example of the first aspect, before the calling the retransmission detection algorithm corresponding to the connected state, and performing the retransmission detection according to the current packet sequence number, the expected packet sequence number, and the hole length, the method further includes:
determining whether the data packet is a target data packet, where the target data packet includes at least one of the following: a keepalive probe packet, a zero-window probe packet, and a zero-window recovery packet; and
if the data packet is the target data packet, determining that the data packet does not contain the retransmitted data.

Based on the ninth example of the first aspect, in a tenth example of the first aspect, the determining whether the data packet is a target data packet includes:
obtaining a receive window length, where the receive window length is used to indicate a length of data currently receivable by a receiving end; and
determining whether the data packet is the target data packet according to a payload length of the data packet, the current packet sequence number, the expected packet sequence number, and the receive window length.

Based on the tenth example of the first aspect, in an eleventh example of the first aspect, the determining whether the data packet is the target data packet according to the payload length of the data packet, the current packet sequence number, the expected packet sequence number, and the receive window length includes:
if a payload length of the data packet is within a first length range, and the current packet sequence number and the expected packet sequence number satisfy a first preset relationship, determining that the data packet is the keepalive probe packet;
if a payload length of the data packet is within a second length range, and the current packet sequence number and the expected packet sequence number satisfy a second preset relationship, and a receive window length is within a third length range, determining that the data packet is the zero-window probe packet; and
if a payload length of the data packet is not within the first length range, and the current packet sequence number and the expected packet sequence number satisfy the first preset relationship, and a zero-window probe packet is received before the data packet, determining that the data packet is the zero-window recovery packet.

Based on the eighth example of the first aspect, in a twelfth example of the first aspect, the method further includes:
if the data packet is the zero-window recovery packet or an in-order data packet, updating the expected packet sequence number according to the current packet sequence number and a payload length of the data packet, where a payload length of the in-order data packet is not within the first length range, a packet type of the in-order data packet is the connected data packet, and a packet sequence number of the in-order data packet is the same as the expected packet sequence number before the update; and
if the current packet type includes the disconnected data packet or the connection establishment data packet, updating the expected packet sequence number according to the current packet sequence number, the payload length of the data packet, and a preset sequence number offset.

Based on the second example of the first aspect, in a thirteenth example of the first aspect, the determining, according to the current packet type, the data sending state corresponding to the data packet includes:
if the current packet type satisfies a first preset condition, or the current packet type and the expected packet sequence number satisfy a second preset condition, determine that the data sending state is the disconnected state or the connection establishment state, where the first preset condition includes that the current packet type is the disconnected data packet, and the second preset condition includes that the current packet type includes the connection establishment data packet, and the expected packet sequence number is not an initial packet sequence number; and
the calling the retransmission detection algorithm corresponding to the data sending state, and performing the retransmission detection according to the current packet sequence number and the expected packet sequence number includes:
calling a retransmission detection algorithm corresponding to the disconnected state or the connection establishment state, and performing the retransmission detection according to whether the current packet sequence number is the same as the expected packet sequence number.

In a first example of the second aspect, an embodiment of the present disclosure provides an apparatus for retransmission detection of a data packet. The apparatus includes:
a current packet information determining module, configured to receive the data packet, and obtain a packet type and a packet sequence number of the data packet as a current packet type and a current packet sequence number, respectively;
an expected packet sequence number obtaining module, configured to obtain an expected packet sequence number, where the expected packet sequence number is used to indicate an expected data packet to be received before the data packet arrives;
a state determining module, configured to determine, according to the current packet type, a data sending state corresponding to the data packet and determine a retransmission detection algorithm corresponding to the data sending state, where the data sending state is used to indicate a corresponding connection state when the data packet is sent; and
a retransmission detection module, configured to call the retransmission detection algorithm corresponding to the data sending state, and perform the retransmission detection according to the current packet sequence number and the expected packet sequence number, to determine whether the data packet contains retransmitted data.

Based on the first example of the second aspect, in a second example of the second aspect, the current packet type includes at least one of the following: a connected data packet, a disconnected data packet, and a connection establishment data packet. The data sending state includes at least one of the following: a connected state, a disconnected state, and a connection establishment state. The connected state and the disconnected state correspond to different retransmission detection algorithms, and the connection establishment state and the disconnected state correspond to a same retransmission detection algorithm.

Based on the second example of the second aspect, in a third example of the second aspect, the state determining module is further configured to:
if the current packet type is the connected data packet, determine that the data sending state is the connected state; and
the retransmission detection module is further configured to:
obtain a hole length, and call a retransmission detection algorithm corresponding to the connected state and perform the retransmission detection according to the current packet sequence number, the expected packet sequence number, and the hole length, where the hole length is used to indicate a length of missing data.

Based on the third example of the second aspect, in a fourth example of the second aspect, the connected state includes at least one sub-state, and the calling the retransmission detection algorithm corresponding to the connected state, and perform the retransmission detection according to the current packet sequence number, the expected packet sequence number, and the hole length includes:
determining the sub-state according to the current packet sequence number and the expected packet sequence number, where the sub-state is one of the following: an out-of-order state, an overlapping state, and a wraparound state. The out-of-order state is used to indicate that the data packet does not arrive in a packet sequence number order. The overlapping state is used to indicate that the data packet contains both the retransmitted data and data to be transmitted. The wraparound state is used indicate that a packet sequence number wraps around during transmission of the data packet; and
calling a retransmission detection algorithm corresponding to the sub-state, and performing the retransmission detection according to the current packet sequence number, the expected packet sequence number, and the hole length.

Based on the fourth example of the second aspect, in a fifth example of the second aspect, the retransmission detection module is further configured to:
if the current packet sequence number is less than the expected packet sequence number, determine that the sub-state is the out-of-order state or the overlapping state, where the out-of-order state and the overlapping state correspond to a same retransmission detection algorithm;
determining, according to the current packet sequence number, a payload length of the data packet, and the expected packet sequence number, a length of first data in the data packet that is located before the expected packet sequence number;
if the length of the first data is greater than the hole length, determining that the data packet contains the retransmitted data, and updating the hole length to 0; and
if the length of the first data is less than or equal to the hole length, determining that the data packet does not contain the retransmitted data, and decreasing the hole length according to the length of the first data.

Based on the fifth example of the second aspect, in a sixth example of the second aspect, the retransmission detection module is further configured to:
if the current packet sequence number is less than the expected packet sequence number, and an end data sequence number of the data packet is greater than or equal to the expected packet sequence number, updating the expected packet sequence number according to the payload length of the data packet and the current packet sequence number.

Based on the fourth example of the second aspect, in a seventh example of the second aspect, the retransmission detection module is further configured to:
if the current packet sequence number is greater than the expected packet sequence number, and a difference between the current packet sequence number and the expected packet sequence number is greater than or equal to a preset threshold, determine that the sub-state is the wraparound state;
the calling the retransmission detection algorithm corresponding to the sub-state, and performing the retransmission detection according to the current packet sequence number, the expected packet sequence number, and the hole length includes:
obtaining, from the data packet, a length of second data that is located before the expected packet sequence number and that is located after the current packet sequence number;
if the length of the second data of the data packet is greater than the hole length, determining that the data packet contains the retransmitted data, and updating the hole length to 0; and
if the length of the second data is less than or equal to the hole length, determining that the data packet does not contain the retransmitted data, and decreasing the hole length according to the length of the second data.

Based on the seventh example of the second aspect, in an eighth example of the second aspect, the retransmission detection module is further configured to:
if the current packet sequence number is greater than the expected packet sequence number, and a difference between the current packet sequence number and the expected packet sequence number is less than the preset threshold, determine that the sub-state is not the wraparound state, to increase the hole length according to the difference between the current packet sequence number and the expected packet sequence number, and update the expected packet sequence number according to the current packet sequence number and a payload length of the data packet.

Based on the third to eighth examples of the second aspect, in a ninth example of the second aspect, the retransmission detection module is further configured to:
before calling the retransmission detection algorithm corresponding to the connected state, and performing retransmission detection according to the current packet sequence number, the expected packet sequence number, and the hole length, determine whether the data packet is a target data packet, where the target data packet includes at least one of the following: a keepalive probe packet, a zero-window probe packet, and a zero-window recovery packet; and
if the data packet is the target data packet, determine that the data packet does not contain the retransmitted data.

Based on the ninth example of the second aspect, in a tenth example of the second aspect, the retransmission detection module is further configured to:
obtain a receive window length, where the receive window length is used to indicate a length of data currently receivable by a receiving end; and
determine whether the data packet is the target data packet according to a payload length of the data packet, the current packet sequence number, the expected packet sequence number, and the receive window length.

Based on the tenth example of the second aspect, in an eleventh example of the second aspect, the retransmission detection module is further configured to:
if a payload length of the data packet is within a first length range, and the current packet sequence number and the expected packet sequence number satisfy a first preset relationship, determine that the data packet is the keepalive probe packet;
if a payload length of the data packet is within a second length range, and the current packet sequence number and the expected packet sequence number satisfy a second preset relationship, and a receive window length is within a third length range, determine that the data packet is the zero-window probe packet; and
if a payload length of the data packet is not within the first length range, and the current packet sequence number and the expected packet sequence number satisfy the first preset relationship, and a zero-window probe packet is received before the data packet, determine that the data packet is the zero-window recovery packet.

Based on the eighth example of the second aspect, in a twelfth example of the second aspect, the retransmission detection module is further configured to:
if the data packet is the zero-window recovery packet or an in-order data packet, update the expected packet sequence number according to the current packet sequence number and a payload length of the data packet, where a payload length of the in-order data packet is not within the first length range, a packet type of the in-order data packet is the connected data packet, and a packet sequence number of the in-order data packet is the same as the expected packet sequence number before the update; and
if the current packet type includes the disconnected data packet or the connection establishment data packet, update the expected packet sequence number according to the current packet sequence number, the payload length of the data packet, and a preset sequence number offset.

Based on the second example of the second aspect, in a thirteenth example of the second aspect, the state determining module is further configured to:
if the current packet type satisfies a first preset condition, or the current packet type and the expected packet sequence number satisfy a second preset condition, determine that the data sending state is the disconnected state or the connection establishment state, where the first preset condition includes that the current packet type is the disconnected data packet, and the second preset condition includes that the current packet type includes the connection establishment data packet, and the expected packet sequence number is not an initial packet sequence number; and
the retransmission detection module is further configured to:
call a retransmission detection algorithm corresponding to the disconnected state or the connection establishment state, and perform the retransmission detection according to whether the current packet sequence number is the same as the expected packet sequence number.

According to one or more embodiments of the present disclosure, in a third aspect, an electronic device is provided, and includes at least one processor and a memory.

The memory stores computer-executable instructions.

The at least one processor executes the computer-executable instructions stored in the memory, so that the electronic device implements the method according to any one of the first aspect.

According to one or more embodiments of the present disclosure, in a fourth aspect, a computer-readable storage medium is provided. Computer-executable instructions are stored in the computer-readable storage medium. When a processor executes the computer-executable instructions, a computing device is enabled to implement the method according to any one of the first aspect.

According to one or more embodiments of the present disclosure, in a fifth aspect, a computer program is provided. The computer program is configured to implement the method according to any one of the first aspect.

The foregoing descriptions are merely preferred embodiments of the present disclosure and descriptions of the applied technical principles. A person skilled in the art should understand that the scope of disclosure involved in the present disclosure is not limited to the technical solutions formed by a specific combination of the foregoing technical features, and shall also cover other technical solutions formed by any combination of the foregoing technical features or equivalent features thereof without departing from the foregoing concept of disclosure. For example, a technical solution formed by replacing the foregoing features with technical features with similar functions disclosed in the present disclosure (but not limited thereto).

In addition, although the operations are depicted in a specific order, it should be understood as requiring these operations to be performed in the specific order shown or in a sequential order. Under specific circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment can also be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

What is claimed is:

1. A method for retransmission detection of a data packet, comprising:
receiving the data packet, and obtaining a packet type and a packet sequence number of the data packet as a current packet type and a current packet sequence number, respectively;
obtaining an expected packet sequence number, wherein the expected packet sequence number is used to indicate an expected data packet to be received before the data packet arrives;
determining, according to the current packet type, a data sending state corresponding to the data packet and determining a retransmission detection algorithm corresponding to the data sending state, wherein the data sending state is used to indicate a corresponding connection state when the data packet is sent; and
calling the retransmission detection algorithm corresponding to the data sending state, and performing the retransmission detection according to the current packet sequence number and the expected packet sequence number, to determine whether the data packet contains retransmitted data.

2. The method according to claim 1, wherein the current packet type comprises at least one of the following: a connected data packet, a disconnected data packet, and a connection establishment data packet; the data sending state comprises at least one of the following: a connected state, a disconnected state, and a connection establishment state; the connected state and the disconnected state correspond to different retransmission detection algorithms, and the connection establishment state and the disconnected state correspond to a same retransmission detection algorithm.

3. The method according to claim 2, wherein the determining, according to the current packet type, the data sending state corresponding to the data packet comprises:
if the current packet type is the connected data packet, determining that the data sending state is the connected state; and
the calling the retransmission detection algorithm corresponding to the data sending state, and performing the retransmission detection according to the current packet sequence number and the expected packet sequence number comprises:
obtaining a hole length, and calling a retransmission detection algorithm corresponding to the connected state, and performing the retransmission detection according to the current packet sequence number, the expected packet sequence number, and the hole length, wherein the hole length is used to indicate a length of missing data.

4. The method according to claim 3, wherein the connected state comprises at least one sub-state, and the calling the retransmission detection algorithm corresponding to the connected state, and performing the retransmission detection according to the current packet sequence number, the expected packet sequence number, and the hole length comprises:
determining the sub-state according to the current packet sequence number and the expected packet sequence number, wherein the sub-state is one of the following: an out-of-order state, an overlapping state, and a wraparound state, the out-of-order state is used to indicate that the data packet does not arrive in a packet sequence number order, the overlapping state is used to indicate that the data packet contains both the retransmitted data and data to be transmitted, and the wraparound state is used to indicate that a packet sequence number wraps around during transmission of the data packet; and
calling a retransmission detection algorithm corresponding to the sub-state, and performing the retransmission detection according to the current packet sequence number, the expected packet sequence number, and the hole length.

5. The method according to claim 4, wherein the determining the sub-state according to the current packet sequence number and the expected packet sequence number comprises:
if the current packet sequence number is less than the expected packet sequence number, determining that the sub-state is the out-of-order state or the overlapping state, wherein the out-of-order state and the overlapping state correspond to a same retransmission detection algorithm; and
the calling the retransmission detection algorithm corresponding to the sub-state, and performing the retransmission detection according to the current packet sequence number, the expected packet sequence number, and the hole length comprises:
determining, according to the current packet sequence number, a payload length of the data packet, and the expected packet sequence number, a length of first data in the data packet that is located before the expected packet sequence number;
if the length of the first data is greater than the hole length, determining that the data packet contains the retransmitted data, and updating the hole length to 0;
if the length of the first data is less than or equal to the hole length, determining that the data packet does not contain the retransmitted data, and decreasing the hole length according to the length of the first data.

6. The method according to claim 5, further comprising:
if the current packet sequence number is less than the expected packet sequence number, and an end data sequence number of the data packet is greater than or equal to the expected packet sequence number, updating the expected packet sequence number according to the payload length of the data packet and the current packet sequence number.

7. The method according to claim 4, wherein the determining the sub-state according to the current packet sequence number and the expected packet sequence number comprises:
if the current packet sequence number is greater than the expected packet sequence number, and a difference between the current packet sequence number and the expected packet sequence number is greater than or equal to a preset threshold, determining that the sub-state is the wraparound state; and
the calling the retransmission detection algorithm corresponding to the sub-state, and performing the retransmission detection according to the current packet sequence number, the expected packet sequence number, and the hole length comprises:
obtaining, from the data packet, a length of second data that is located before the expected packet sequence number and that is located after the current packet sequence number;
if the length of the second data of the data packet is greater than the hole length, determining that the data packet contains the retransmitted data, and updating the hole length to 0;
if the length of the second data is less than or equal to the hole length, determining that the data packet does not contain the retransmitted data, and decreasing the hole length according to the length of the second data.

8. The method according to claim 7, further comprising:
if the current packet sequence number is greater than the expected packet sequence number, and a difference between the current packet sequence number and the expected packet sequence number is less than the preset threshold, determining that the sub-state is not the wraparound state, to increase the hole length according to the difference between the current packet sequence number and the expected packet sequence number, and update the expected packet sequence number according to the current packet sequence number and a payload length of the data packet.

9. The method according to claim 3, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

10. The method according to claim 4, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

11. The method according to claim 5, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

12. The method according to claim 6, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

13. The method according to claim 7, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

14. The method according to claim 8, wherein before the calling the retransmission detection algorithm corresponding to the connected state, and performing the retransmission detection according to the current packet sequence number, the expected packet sequence number, and the hole length, the method further comprises:
determining whether the data packet is a target data packet, wherein the target data packet comprises at least one of the following: a keepalive probe packet, a zero window probe packet, and a zero window recovery packet; and
if the data packet is the target data packet, determining that the data packet does not contain the retransmitted data.

15. The method according to claim 9, wherein the determining whether the data packet is the target data packet comprises:
obtaining a receive window length, wherein the receive window length is used to indicate a length of data currently receivable by a receiving end; and
determining whether the data packet is the target data packet according to a payload length of the data packet, the current packet sequence number, the expected packet sequence number, and the receive window length.

16. The method according to claim 15, wherein the determining whether the data packet is the target data packet according to the payload length of the data packet, the current packet sequence number, the expected packet sequence number, and the receive window length comprises:
if the payload length of the data packet is within a first length range, and the current packet sequence number and the expected packet sequence number satisfy a first preset relationship, determining that the data packet is the keepalive probe packet;
if the payload length of the data packet is within a second length range, the current packet sequence number and the expected packet sequence number satisfy a second preset relationship, and the receive window length is within a third length range, determining that the data packet is the zero window probe packet;
if the payload length of the data packet is not within the first length range, the current packet sequence number and the expected packet sequence number satisfy the first preset relationship, and the zero window probe packet is received before the data packet, determining that the data packet is the zero window recovery packet.

17. The method according to claim 16, further comprising:
if the data packet is the zero window recovery packet or an in-order data packet, updating the expected packet sequence number according to the current packet sequence number and the payload length of the data packet, wherein a payload length of the in-order data packet is not within the first length range, a packet type of the in-order data packet is the connected data packet, and a packet sequence number of the in-order data packet is the same as the expected packet sequence number before updating;
if the current packet type comprises the disconnected data packet or the connection establishment data packet, updating the expected packet sequence number according to the current packet sequence number, the payload length of the data packet, and a preset sequence number offset.

18. The method according to claim 2, wherein the determining, according to the current packet type, the data sending state corresponding to the data packet comprises:
if the current packet type satisfies a first preset condition, or the current packet type and the expected packet sequence number satisfy a second preset condition, determining that the data sending state is the disconnected state or the connection establishment state, wherein the first preset condition comprises that the current packet type is the disconnected data packet, and the second preset condition comprises that the current packet type comprises the connection establishment data packet, and the expected packet sequence number is not an initial packet sequence number; and
the calling the retransmission detection algorithm corresponding to the data sending state, and performing the retransmission detection according to the current packet sequence number and the expected packet sequence number comprises:
calling a retransmission detection algorithm corresponding to the disconnected state or the connection establishment state, and performing the retransmission detection according to whether the current packet sequence number is the same as the expected packet sequence number.

19. An electronic device, wherein the electronic device comprises at least one processor and a memory;
the memory stores a computer-executable instruction; and
the at least one processor executes the computer-executable instruction stored in the memory, such that the at least one processor is enabled to:
receive the data packet, and obtain a packet type and a packet sequence number of the data packet as a current packet type and a current packet sequence number, respectively;
obtain an expected packet sequence number, wherein the expected packet sequence number is used to indicate an expected data packet to be received before the data packet arrives;
determine, according to the current packet type, a data sending state corresponding to the data packet and determine a retransmission detection algorithm corresponding to the data sending state, wherein the data sending state is used to indicate a corresponding connection state when the data packet is sent; and
call the retransmission detection algorithm corresponding to the data sending state, and perform the retransmission detection according to the current packet sequence number and the expected packet sequence number, to determine whether the data packet contains retransmitted data.

20. A non-transitory computer-readable storage medium, wherein the computer-readable storage medium stores a computer-executable instruction, and when a processor executes the computer-executable instruction, the computer-executable instruction enables a computing device to
receive the data packet, and obtain a packet type and a packet sequence number of the data packet as a current packet type and a current packet sequence number, respectively;
obtain an expected packet sequence number, wherein the expected packet sequence number is used to indicate an expected data packet to be received before the data packet arrives;
determine, according to the current packet type, a data sending state corresponding to the data packet and determine a retransmission detection algorithm corresponding to the data sending state, wherein the data sending state is used to indicate a corresponding connection state when the data packet is sent; and
call the retransmission detection algorithm corresponding to the data sending state, and perform the retransmission detection according to the current packet sequence number and the expected packet sequence number, to determine whether the data packet contains retransmitted data.
